(19) United States
(12) Patent Application Publication
(10) Pub. No.: US 2002/0198318 A1
(43) Pub. Date: Dec. 26, 2002

(54) Polypropylene-based resin composition, process for producing the same and stretched film containing the same

(75) Inventors: Yoichi Obata, Sodegaura-shi (JP); Takeshi Ebara, Chiba-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/107,193

(22) Filed: Mar. 28, 2002

(30) Foreign Application Priority Data
Mar. 30, 2001 (JP) 2001-100616

(51) Int. Cl. C08L 53/00; C08L 23/04

(52) U.S. Cl. 525/88; 525/240

(57) ABSTRACT

A polypropylene-based resin composition for a stretched film, comprising 20 to 99.99% by weight of a propylene-based polymer(A) having a die swelling ratio of less than 1.7, and 0.01 to 80% by weight of apropylene-based polymer(B) having a die swelling ratio of 1.8 or more.

### BACKGROUND OF THE INVENTION

1. Field of The Invention

The present invention relates to apolypropylene-based resin composition suitable for a stretch film, a process for producing the resin composition, and a stretch film made of the resin composition. More specifically, the present invention relates to a polypropylene-based resin composition suitable for a stretch film having superior rigidity and stretching processability, and a small heat shrinkage percentage, to a process for producing the resin composition, and to a polypropylene-based stretch film containing the resin composition.

2. Description of Related Art

Polypropylene-based stretch films have been widely used as packaging materials, and a method of mixing polypropylenes having different physical properties has been conventionally known for improving the physical properties and stretching processability of a polypropylene-based stretch film.

For example, a process of mixing polypropylenes having different molecular weight has been known, and JP58-173141A discloses a process for producing a polypropylene-based resin composition for extrusion stretching excellent in superior extrudability and stretchability, comprising producing a propylene homopolymer or a random copolymer having a melt flow index of 0.02 to 5 g/10 min. and a propylene homopolymer or a random copolymer having a melt flow index of 50 to 1000 g/10 min. by multi-step polymerization.

Further, JP06-248133A discloses a polypropylene composition, comprising a polypropylene of relatively high molecular weight, having an intrinsic viscosity of 1.0 or more and an isotactic pentad fraction of 0.90 or more, and a polypropylene of relatively low molecular weight and high stereoregularity, having an intrinsic viscosity of 0.1 to 0.8 and an isotactic pentad fraction of 0.93 or more, and being rich in moldability and superior in balance between rigidity and impact resistance.

Further, JP-A-11-228629 discloses a propylene-based polymer having a superior balance in melt strength, elongation property and flowability, obtained, in two-step polymerization, by producing a crystalline propylene polymer component having an intrinsic viscosity of 5 dl/g or more in the first step and sequentially producing a crystalline propylene polymer component having an intrinsic viscosity of less than 3 dl/g in the second step.

However, it has been desired to improve rigidity, heat shrinkage percentage and stretchability, in order to use the polypropylene compositions which are disclosed in the above-mentioned publication, as a stretched film.

### SUMMARY OF THE INVENTION

An object of the present invention is to provide a polypropylene-based resin composition for a stretch film having a superior rigidity and stretchability, and a small heat shrinkage percentage, to a process for producing a resin composition thereof, and to a polypropylene-based stretched film made of the resin composition.

Under these circumstances, the present inventors have intensively studied, and as a result, have found that a polypropylene-based resin composition comprising a propylene-based polymer having a low die swelling ratio in a specific range and a propylene-based polymer having a high die swelling ratio in a specific range, and completed the present invention.

Namely, the present invention relates to a polypropylene-based resin composition for a stretched film, comprising 20 to 99.99% by weight of a propylene polymer(A) having a die swelling ratio of less than 1.7, and 0.01 to 80% by weight of a propylene-based polymer(B) having a die swelling ratio of 1.8 or more, to a process for producing the resin composition, and to a polypropylene-based stretched film containing the resin composition.

The present invention is illustrated in detail below.

### DETAILED DESCRIPTION OF THE INVENTION

The die swelling ratio of the propylene polymer(A) is less than 1.7, and the die swelling ratio of the propylene-based polymer(B) is 1.8 or more.

The above-mentioned die swelling ratio is a ratio of a diameter of a section of a sample which is extruded from an orifice at measuring amelt flow rate(MFR), to a diameter of the orifice.

The die swelling ratio of the propylene-based polymer (A) is preferably 1 to 1.6 from the viewpoint of the heat shrinkage percentage, more preferably 1.05 to 1.5, and further preferably 1.1 to 1.35. When the die swelling ratio of the propylene polymer(A) is 1.7 or more, the transparency of the stretched film obtained may be deteriorated.

The die swelling ratio of the propylene-based polymer(B) is preferably 1.8 to 3 from the viewpoint of the stretched film obtained, more preferably 1.9 to 3, and further preferably 2.0 to 3. When the die swelling ratio of the propylene polymer(B) is less than 1.8, the stretchability may be inadequate.

The content of the propylene polymer(A) used in the present inventionis 20 to 99.99% byweight, andthecontent of the propylene polymer(B) is 0.01 to80% byweight. Herein, the total amount of (A) and (B) is 100% by weight. The propylene polymer (A) is preferably 50 to 99.9% by weight, and the propylene polymer (A) is more preferably 80 to 99.8% by weight.

When the content of the propylene polymer(A) is less than 20% by weight, the stretchability of the polypropylene resin composition may be deteriorated, and when the content of the propylene-basedpolymer (A) exceeds 99.99% by weight, the rigidity of the polypropylene-based stretched film obtained may be insufficient, and the heat shrinkage percentage of the polypropylene-based stretch film obtained may become large.

The propylene polymer(A) used in the present invention is a propylene homopolymer or a propylene random copolymer. The propylene random copolymer is a random copolymer obtained by copolymerizing propylene with at least one comonomer selected from the group consisting of ethylene and α-olefins having 4 to 20 carbon atoms. Examples thereof include a propylene-ethylene random copolymer, a propylene-α-olefin random copolymer, a propylene-ethylene-α-olef in random copolymer.

Examples of the α-olefin having 4 to 20 carbon atoms include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonen, 1-decene, 1-undecene, 1-dodecene and the like. 1-Butene, 1-pentene, 1-hexene and 1-octene are preferable, and 1-butene and 1-hexene are more preferable.

When the propylene polymer(A) is a propylene-ethylene random copolymer, the ethylene content is preferably 4% by weight or less from the viewpoint of the rigidity of the stretch film obtained, more preferably 3.5% by weight or less, and further preferably 3% by weight or less.

When the propylene polymer(A) is a propylene-α-olefin random copolymer, the α-olefin content is preferably 15% by weight or less from the viewpoint of the rigidity of the stretch film obtained, more preferably 12% by weight or less, and further preferably 8% by weight or less.

When the propylene polymer(A) is a propylene-ethylene-α-olefin random copolymer, the total content of ethylene and the α-olefin is preferably 15% by weight or less from the viewpoint of the rigidity of the polypropylene-based stretch film obtained, more preferably 12% by weight or less, and further preferably 8% by weight or less.

The melt flow rate (hereinafter, abbreviated as MFR) of the propylene polymer(A) is preferably 0.1 to 20 g/10 min. from the viewpoint of the flowability at extrusion processing and the stretchability of the polypropylene-based resin composition, more preferably 0.5 to 15 g/10 min., and further preferably 1 to 10 g/10 min.

The melting point(Tm) of the propylene polymer(A) is preferably 140 to 170° C. from the viewpoint of exhibiting a good stretch processability and rigidity and a small heat shrinkage percentage, more preferably 155 to 167° C., and further preferably 160 to 166° C.

Herein, the melting point(Tm) is determined from the peak temperature of a melting curve of a polymer measured by a differential scanning calorimeter (DSC).

The amount of 20° C. xylene-soluble portion (hereinafter, abbreviated as CXS) of the propylene polymer(A) is preferably 4% by weight or less from the viewpoint of exhibiting of an anti-blocking property, and a good stretch processability and rigidity, and a small heat shrinkage percentage, more preferably 3.5% by weight or less, and further preferably 3% by weight or less.

As the catalyst used for production of the propylene polymer (A) used in the present invention, a catalyst for stereoregular polymerization of propylene is used, and for example, a catalyst system combining a solid catalyst component such as a titanium trichloride catalyst, Ti-Mg-based catalyst containing titanium, magnesium, halogen and an electron donor compound as essential components, or the like, with an organoaluminum compound and optionally the third component such as an electron donor compound or the like; a metallocene catalyst or the like is mentioned. A catalyst system obtained by combining a solid catalyst component containing magnesium, titanium, halogen and an electron donor as essential components, an organoaluminum compound and a third component, is preferable, and for example, catalyst systems described in U.S. Pat. No. 5,608,018, 4,743,665 and 4,672,050 are mentioned.

The propylene polymer(B) is not specifically limited, and known propylene polymers can be used. For example, a non-linear propylene polymer resin having a strain hardening elongation viscosity, in other words, high melt tension, a propylene polymer resin produced by a multi-step polymerization and having a broad molecular weight distribution, and the like are mentioned.

The MFR of the propylene polymer(B) is preferably 0.1 to 200 g/10 min. from the viewpoint of stretch processability and prevention of generation of granule structures in a stretched film formed, more preferably 0.5 to 200 g/10 min., and further preferably 0.6 to 60 g/10 min.

The melting point(Tm) of the propylene polymer(B) is preferably 130 to 170° C. from the viewpoint of exhibiting a rigidity of the polypropylene-based stretch film together with a good stretchability and modulus and a small heat shrinkage percentage, more preferably 140 to 167° C., and further preferably 160 to 166° C.

The amount of 20° C. xylene-soluble portion (CXS) of the propylene polymer(B) is preferably 10% by weight or less from the viewpoint of exhibiting an anti-blocking property together with a good stretchability and rigidity and a small heat shrinkage percentage, more preferably 6% by weight or less, and further preferably 4% by weight or less.

As a catalyst used for production of the propylene polymer (B) used in the present invention, a catalyst for stereoregular polymerization of propylene is used, and specifically, a similar catalyst as the catalyst used for production of the fore-mentioned propylene polymer(A) is mentioned.

The propylene polymer(B) is preferably a propylene polymer (C) which is obtained by a polymerization process containing a step of producing 0.05 to 35% by weight of a crystalline propylene polymer portion(a) having an intrinsic viscosity of 5 dl/g or more and a step of producing 99.95 to 65% by weight of a crystalline propylene polymer portion(b) having an intrinsic viscosity of less than 3 dl/g, and has an intrinsic viscosity of less than 3 dl/g and a molecular weight distribution represented by a ratio of a weight average molecular weight(Mw) to a number average molecular weight(Mn) of less than 10.

The above-mentioned crystalline propylene polymer portion(a) and crystalline propylene polymer portion(b) may be the same or different, and are a crystalline propylene polymer portion respectively having an isotactic structure, and preferably a propylene homopolymer and a copolymer of propylene with comonomers such as ethylene and/or α-olefin having 4 to 12 carbon atoms in an amount of a degree of not loosing crystallinity.

Examples of the α-olef in having 4 to 12 carbon atoms include 1-butene, 4-methyl-1-pentene, 1-hexene, 1-octene, and the like, and 1-butene is most preferable.

The amount of a degree of not loosing crystallinity differs depending on the kind of the comonomers, and for example, in case of a copolymer of propylene with ethylene, the content of repeating units derived from ethylene is 10% byweight or less, and in case of acopolymer of propylene with an α-olefin, the content of repeating units derived from the α-olefin in the copolymer is 30% by weight or less.

The above-mentioned crystalline propylene polymer portion(a) and crystalline propylene polymer portion(b) are preferably in particular, a propylene homopolymer, a random copolymer of propylene with ethylene in which the content of repeating units derived from ethylene is 10% by weight or less, a random copolymer of propylene with α-olef in having 4 to 12 carbon atoms in which the content of a repeating unit derived from α-olefin is 30% by weight or less, or a random terpolymer of propylene with ethylene and α-olefin having 4 to 12 carbon atoms in which the content of repeating units derived from ethylene is 10% by weight or less and the content of repeating units derived from α-olefin is 30% by weight or less.

A part of the above-mentioned crystalline propylene polymer portion(a) and a part of the above-mentioned crystalline propylene polymer portion (b) may be bonded.

Examples of the process for producing the above-mentioned propylene polymer(C) include a batchwise polymerization process comprising producing the crystalline propylene polymer portion(a) in the presence of a polymerization catalyst in a polymerization vessel at the first stage and successively producing the crystalline propylene polymer portion(b) in the same polymerization vessel; a continuous polymerization process using at least two polymerization vessels connected in serious comprising producing the crystalline propylene polymer portion(a) in the presence of a polymerization catalyst in the first polymerization vessel(first step), transferring a product produced in the first vessel to the next polymerization vessel and producing the crystalline propylene polymer portion(b) in the polymerization vessel(second step); and the like. Further, the polymerization vessels used in the first step and the second step may be respectively one vessel or 2 or more vessels.

As the catalyst used for polymerization of the above-mentioned propylene polymer(C), a catalyst for stereo-regular polymerization of propylene is used, and specifically, a similar catalyst as the catalyst used for polymerization of the fore-mentioned propylene polymer(A) is mentioned.

The intrinsic viscosity[η]ₐ of the fore-mentioned crystalline propylene polymer portion (a) is preferably 5 dl/g or more from the viewpoint of the stretchability of the polypropylene-based resin composition for a stretched film and heat shrinkage percentage of the stretch film, and more preferably 6 dl/g or more. The higher the intrinsic viscosity[η]ₐ of the fore-mentioned polymer portion (a), the more preferable it is, and there is particularly no upper limitation, but it is usually less than 15 dl/g. The intrinsic viscosity[η]ₐ of the fore-mentioned polymer portion (a) is more preferably 6 to 13 dl/g and most preferably 7 to 11 dl/g.

The content(Wₐ) of the fore-mentioned crystalline propylene polymer portion(a) in the polymer(C) is preferably 0.05 to 35% by weight (namely, the content W_{b} of the fore-mentioned crystalline propylene polymer portion (b) is 99.95 to 65% by weight) from the viewpoint of the easiness of adjusting the die swelling ratio, more preferably 0.1 to 25% by weight (namely, the content proportion W_{b} of the fore-mentioned crystalline propylene polymer portion (b) is 99.9 to 75% by weight), and further preferably 0.3 to 18% by weight (namely, the content proportion W_{b} of the fore-mentioned crystalline propylene polymer portion (b) is 99.7 to 82% by weight).

The intrinsic viscosity [η]ₐ (dl/g) and the content Wₐ( by weight) of the fore-mentioned crystalline propylene polymer portion (a) preferably satisfy the relation of (Expression 1) described below, from the viewpoint of the melt strength of the fore-mentioned propylene polymer (C) and the easiness of adjusting the die swelling ratio of the polypropylene-based resin composition for a stretched film.

Wₐ24 400×exp(−0.6×[η]ₐ) (Expression 1)

The intrinsic viscosity [η]_{b} of the fore-mentioned crystalline propylene polymer portion(b) is preferably less than 3 dl/g from the viewpoint of the stretchability and the flowability and processability of the polypropylene-based resin composition, and more preferably 2 dl/g or less. The lower the intrinsic viscosity [η]_{b} of the fore-mentioned polymer portion (b), the more preferable it is, and there is particularly no lower limitation, but it is usually 0.5 dl/g or more. The intrinsic viscosity [η]_{b} of the fore-mentioned polymer portion(b) is more preferably 0.8 to 2 dl/g and most preferably 1 to 1.8 dl/g.

The intrinsic viscosity[η]_{b} of the fore-mentioned crystalline propylene polymer portion(b) can be adjusted by appropriately setting the production condition of the polymer portion(b), and is usually determined from (Expression 2) described below, using the intrinsic viscosity[η]_{c} , of the propylene polymer(C), the intrinsic viscosity[η]ₐ of the polymerportion (a), and the respective contents (Wₐ and W_{b}) (% by weight) of the polymer portion(a) and the polymer portion(b):

[η]_{b}=([η]_{c}×100−[η]ₐ×Wₐ)÷W_{b} (Expression 2)

[η]_{c} : Intrinsic viscosity (dl/g) of propylene polymer(C)

[η]ₐ : Intrinsic viscosity (dl/g) of crystalline propylene polymer portion(a)

Wₐ : Content (% by weight) of crystalline propylene polymer portion(a)

W_{b} : Content (% by weight) of crystalline propylene polymer portion(b)

The intrinsic viscosity [η]_{c} of the fore-mentioned propylene polymer (C) is preferably less than 3 dl/g from the viewpoint of the flowability and processability of the polypropylene-based resin composition for stretch. The lower the intrinsic viscosity [η]_{c} of the fore-mentioned polymer (C), the more preferable it is, and there is no lower limitation in particular, but it is usually 1 dl/g or more. The intrinsic viscosity [η]_{c} of the fore-mentioned polymer (C) is more preferably 1 dl/g or more and less than 3 dl/g and further preferably 1.2 to 2.8 dl/g.

The molecular weight distribution of the fore-mentioned propylene polymer(C) is preferably less than 10 from the viewpoint of the stretch processability of the polypropylene-based resin composition for stretch, and more preferably 4 to 8. Further, the above-mentioned molecular weight distribution is a ratio (Mw/Mn) of weight average molecular weight(Mw) to number average molecular weight(Mn).

The melt flow rate (MFR) of the polypropylene-based resin composition for stretch of the present invention is preferably 0.1 to 20 g/10 min. from the viewpoint of the flowability and the stretch processability at extrusion processing of the polypropylene-based resin composition for stretch, more preferably 0.5 to 15 g/10 min., and further preferably 1 to 10 g/10 min.

Themeltingpoint(Tm) of thepolypropylene-basedresin composition for stretch of the present invention is preferably 145 to 167° C. from the viewpoint of expressing the good stretch processability and the rigidity and the heating shrinkage percentage, more preferably 150 to 166° C., and further preferably 155 to 165° C.

The amount of 20° C. xylene-soluble portion (CXS) of the polypropylene-based resin composition for stretch of the present invention is preferably 4% by weight or less from the viewpoint of exhibiting anti-blocking property and the good stretch processability together with rigidity and the heat shrinkage percentage, more preferably 3.5% by weight or less, and further preferably 3% by weight or less.

As the process for producing the polypropylene-based resin composition of the present invention, a process of respectively and separately polymerizing the propylene-based polymer(A) and the propylene-based polymer(B) and mixing the polymer(A) and the polymer(B), a process of polymerizing the propylene-based polymer(A) and the propylene-based polymer(B), respectively at any one of steps using a multi-step polymerization process having at least two steps, and the like, are mentioned.

A process of respectively and separately polymerizing the propylene-based polymer(A) and the propylene-based polymer(B) in a process of respectively and separately polymerizing the propylene-based polymer(A) and the propylene-based polymer(B) and mixing the polymer (A) and the polymer(B) which was obtained by being respectively and separately polymerized, is not specifically limited, and a solvent polymerization process which is carried out in the presence of an inert solvent, a bulk polymerization process which is carried out in the presence of a liquid monomer, a gas phase polymerization process which is carried out in the absence of a substantially liquid medium, and the like are mentioned, and the gas phase polymerization process is preferable. Further, a polymerization process combining 2 or more of the above-mentioned polymerization process, a multi-step polymerization process having at least two steps are also mentioned.

A process of mixing the propylene-based polymer(A) and the propylene-based polymer(B) is not specifically limited, and for example,

(1) a process of mixing the polymer(A) and the polymer (B) with a ribbon blender, a Henschel mixer, a tumbler mixer or the like, and melt-kneading the mixture with an extruder or the like,

(2) a process of respectively melt-kneading the polymer(A) and the polymer(B) to pelletize them, and then further melt-kneading the mixture which was obtained by mixing these according to the similar process as described above,

(3) aprocess ofrespectively melt-kneading the polymer(A) and the polymer(B) to pelletize them, blending these pellets by dry blend or the like, and then directly mixing the blended mixture using a film forming machine,

(4) a process of respectively melt-kneading the polymer (A) and the polymer (B) to pelletize them, then separately feeding these to the extruder of a film forming machine and mixing them, and the like are mentioned.

In the polypropylene-based resin composition for stretch of the present invention, a stabilizer, alubricant, an antistatic agent, an antiblocking agent, various inorganic or organic fillers may be added at melt-kneading, within the scope of not damaging the object and effect of the present invention. Further, a master batch containing 1 to 99 parts by weight of the propylene-based polymer(A) per 100 parts by weight of parts by weight of the propylene-based polymer(B) is preliminarily prepared, and the master batch may be appropriately mixed so as to be a predetermined concentration.

As a process of polymerizing the propylene-based polymer(A) and the propylene-based polymer(B) at any one of steps using a multi-step polymerization process having at least two steps, a process of combining at least two steps of the same or different polymerization processes which are selected from a solvent polymerization process which is carried out in the presence of an inert solvent, a bulk polymerization process which is carried out in the presence of a liquid monomer, a gas phase polymerization process which is carried out in the absence of a substantially liquid medium and the like, is mentioned; and it is a process in which the propylene-based polymer(A) and the propylene-based polymer(B) are polymerized at any one of steps of the process.

The polypropylene-based resin composition which was obtained by the above-mentioned process of polymerizing the propylene-based polymer(A) and the propylene-based polymer(B) at any one of steps using a multi-step polymerization process having at least two steps, may be further mixed, and as the mixing process thereof, a process of melt-kneading using an extruder or the like is mentioned. At this time, astabilizer, alubricant, an antistatic agent, an antiblocking agent, various inorganic or organic fillers may be added in the polypropylene-based resin composition for stretched film of the present invention at melt-kneading.

In the production of the polypropylene-based resin composition for stretched film, as the catalyst used for polymerization of the propylene-based polymer(A) and the propylene-based polymer B), a catalyst for stereo-regular polymerization of propylene is used in a case of separately polymerizing or in a case of using a multi-step polymerization process, and specifically, a similar catalyst as the catalyst used for polymerization of the fore-mentioned propylene-based polymer(A) is mentioned.

The film forming and stretching process of the polypropylene-based stretched film of the present invention is not specifically limited, and in general, a machine direction uniaxial stretching, a transverse direction uniaxial stretching, a sequential biaxial stretching, a simultaneous biaxial stretching, a tubular biaxial stretching, and the like are mentioned. These stretch systems are illustrated below.

### Machine Direction Uniaxial Stretching

The polypropylene-based resin composition is melted by an extruder, then, extruded through a T die, and solidified in the form of sheet by cooling with a cooling roller. Then, the resulted sheet is pre-heated and stretched in the machine direction by a series of heating rolls, and if necessary, subjected to a corona treatment or the like, and wound.

### Transverse Direction Uniaxial Stretching

The polypropylene-based resin composition is melted by an extruder, then, extruded through a T die, and solidified in the form of sheet bv cooling with a cooling roller. Then, both ends of the resulted sheet are clamped by two lines of chucks arranged along the flow direction, and stretched in the transverse direction by spreading the interval of the above-mentioned two lines of chucks in a heating furnace composed of a pre-heating part, stretching part and heat treatment part, and if necessary, subjected to a corona treatment or the like, and wound.

### Sequential Biaxial Stretching

The polypropylene-based resin composition is melted by an extruder, then, extruded through a T die, and solidified by cooling with a cooling roll. Then, the resulted sheet is pre-heated and stretched in the machine direction by a series of heating rolls. Subsequently, both ends of the resulted sheet are clamped by two lines of chucks arranged along the flow direction, and stretched in the transverse direction by spreading the interval of the above-mentioned two lines of chucks in a heating furnace composed of a pre-heating part, stretching part and heat treatment part, and if necessary, subjected to a corona treatment or the like, and wound.

The fusion temperature of the polypropylene-based resin composition in the sequential biaxial stretching is usually from 230to290° C. The machine direction stretching temperature is usually from 130 to 150° C., and the machine direction stretching magnification is usually from 4 to 6. The transverse stretching temperature is usually from 150 to 165° C., and the transverse stretching magnification is usually from 8 to 10.

### Simultaneous Biaxial Stretching

The polypropylene-based resin composition is melted by an extruder, then, extruded through a T die, and solidifiedby coolingwith a cooling roller. Subsequently, both ends of the resulted sheet are clamped by two lines of chucks arranged along the flow direction, and stretched in the machine direction and transverse direction simultaneously by spreading the interval of the above-mentioned two lines of chucks and the interval between chucks in individual line in a heating furnace composed of a pre-heating part, stretching part and heat treatment part, and if necessary, subjected to a corona treatment or the like, and wound.

### Tubular Biaxial Stretching

The polypropylene-based resin composition is melted by an extruder, then, extruded through an annular die, and solidified in the form of tube by cooling in a water tank. Then, the resulted tube is pre-heated with a heat furnace or a series of heat rolls, then, passed through low speed nip rolls, andwoundwith high speed nip rolls tobe stretched along the flow direction. In this operation, the tube is stretched also in the transverse direction, by swelling the tube with the action of internal pressure of air accumulated between the low speed nip rolls and the high speed nip rolls. The stretched film passed through the high speed nip rolls is thermally treated by a heating furnace or series of heat rolls, and if necessary, subjected to a corona treatment or the like, and wound.

### EXAMPLES

The present invention is further illustrated in detail according to Examples and Comparative Examples, and the present invention is not limited thereto.

The method of forming a film and the evaluation of the stretching processability used in Examples and Comparative Examples are shown below:

### (I) Film Forming

The polypropylene-based resin composition was extruded at a resin temperature of 260° C. using a T-die sheet forming machine having a screw diameter of 65 mmφ, solidified by a cooling roll of 30° C. to prepare a sheet having a thickness of 1 mm. Then, the sheet was stretched between rolls at a stretching temperature of 145° C. and a stretching magnification of 5 to a machine direction (MD) using a longitudinal stretching machine. Then, after the sheet after the longitudinal stretch is stretched at a stretch temperature of 151° C. and a stretching magnification (mechanical magnification) of 8 to a transverse direction (TD) using a tenter-system transverse stretching machine, thermal treatment was carried out by mitigating by 6.5% at 165° C., and a film having a thickness of 25 μm was prepared at a film-forming speed of 25 m/min. Further, a film which was obtained by aging the obtained film at 40 ° C. for 3 days for measurement of film properties.

### (II) Evaluation of Stretchability

The polypropylene-based resin composition was extruded at aresin temperature of 260 ° C. using a T-die sheet processing machine having a screw diameter of 65 mmφ, solidified by a cooling roll of 30 ° C. to prepare a sheet having a thickness of 1 mm. Then, the sheet was stretched between rolls at a stretching temperature of 120 ° C. and a stretching magnification of 5 to a machine direction (MD) using a longitudinal stretch machine. Then, after the sheet after the longitudinal stretching is stretched at a stretch temperature of 148° C. and a stretching magnification (mechanical magnification) of 8 to a transverse direction (TD) using a tenter-system transverse stretching machine, thermal treatment was carried out by mitigating by 6.5% at 165° C., and a film having a thickness of 25 μm was prepared at a film-forming speed of 25 m/min. The stretching property was evaluated by the appearance of the stretched film. When the appearance of the stretched film was good, the stretching property was referred to as good, and when the appearance was bad because of the unevenness of stretching, the stretch property was referred to as bad.

The measurement of the respective items in Examples and Comparative Examples was carried out according to the methods below:

(1) Intrinsic Viscosity of Polymer (Unit: dl/g)

Using an Ubbellohde type viscometer, measurement was carried out in tetralin at 135 ° C. Further, the intrinsic viscosity of the crystalline propylene polymer portion (b) of a propylene homopolymer which was obtained in Reference Example 1 described below was determined using the fore-mentioned equation 2.

(2) Melt Flow Rate (MFR, Unit: g/10 min.)

It was measured at 230° C. according to the method of condition 14 of JIS K7210.

(3) Die Swelling Ratio (SR)

The diameter of the section of an extruded article which was obtained at measurement of the melt flow rate (MFR) according to the method of condition 14 of JIS K7210 was measured and the die swelling ratio was determined from the following equation.

Die swelling ratio=Diameter of section of extruded article/Diameter of orifice

(wherein the diameter of the section of an extruded article is the diameter of the section perpendicular to the extrusion direction of the extruded article, and when the fore-mentioned section is not a real circle shape, the average value of the maximum value and the minimum value of the diameter of the fore-mentioned section is referred to as the diameter of the section of the fore-mentioned extruded article.)

(4) Molecular Weight Distribution

It was measured under the conditions described below according to GPC (Gel Permeation Chromatography) method. Further, molecular weight distribution was represented by a ratio,(Mw/Mn) of weight average molecular weight (Mw) to number average molecular weight (Mn).

Machine: 150CV type (manufactured by Milipore Waters Company Ltd.)

Column: Shodex M/S 80

Measurement temperature: 145° C.

Solvent: o-dichlorobenzene

Sample concentration: 5 mg/8 mL

A calibration curve was prepared using standard polystyrenes.

(5) Melting Point (Tm, Unit: ° C.)

Using a differential scanning calorimeter(DSC-7, manufactured by Perkin Elmer Co., Ltd.), apropylene polymer composition was preliminarily molded by a hot press (after preliminary heating at 230° C. for 5 minutes, pressure was raised to 50 kgf/cm² over 3 minutes and was maintained for 2 minutes. Then, it was cooled at 30 ° C. for 5 minutes under a pressure of 30 kgf/cm².), and a sheet having a thickness of 0.5 mm was prepared. After the polymer was thermally treated at 220° C. for 5 minutes under nitrogen atmosphere, 10 mg of the sheet was cooled to 15° C. at a temperature-descending rate of 300 ° C./min., kept at 150° C. for 1 minutes, further, cooled to 50° C. to at a cooling rate of 5° C./min., kept at 50° C. for 1 minutes, further, heated from 50° C. to 180° C. at a heating rate of 5° C./min., and the melt peak temperature at this time was determined as the melting point (Tm).

(6) Amount of 20° C. Xylene-Soluble Component (CXS, Unit: % by Weight)

After 10 g of a propylene-based polymer was dissolved in 1000 ml of boiling xylene, the solution was gradually cooled to 50° C. and then cooled to 20° C. while stirring in iced water. After the solution was left at 20° C. overnight, a polymer deposited was filtered for separation. The xylene was evaporated from the filtrate, the residue was dried under reduced pressure at 60° C., the polymer soluble in 20° C. xylene was collected, and CXS was calculated.

(7) Haze (Unit: %)

It was measured according to ASTM D1103 using the film obtained in the above-mentioned (Description I).

(8) Anti-Blocking Property (Unit: kg/12 cm²)

Two films of 30 mm+150 mm were collected from the film obtained in the above-mentioned (I) Film forming, and parts of 40 mm along the longitudinal direction of two films are piled each other and these were sandwiched between tracing paper, and conditioned under a load of 0.5 kg at 60° C. for 3 hours. Then, the laminate was left under an atmosphere of 23° C. and relative humidity of 50% for 30 minutes or more, and a shearing tensile test was effected at a speed of 200 mm/min. Four measurements were effected on each of four pieces of the same film, the average of data was calculated, to give a value as a strength required for peeling in the test. When the value is smaller, the anti-blocking property is more excellent.

(9) Young's Modulus (Unit: kg/cm²)

From the film obtained in the above-mentioned (I) Film forming, specimens having a width of 20 mm were collected from the machine direction (MD) and the transverse direction (TD), and an S-S curve was recorded by a tensile tester at a chuck interval of 60 mm and a tensile speed of 5 mm/min., and the initial modulus was measured.

(10) Heat Shrinkage Percentage (Unit: %)

From the film obtained in the above-mentioned (I) Film forming, a film specimen of 30 cm along the MD direction and 20 cm along the TD direction was collected, and two parallel lines were drawn at a distance of 10 cm both along the MD direction and TD direction. The specimen was allowed to stand still for 5 minutes in an oven of 120° C., then, removed, and cooled for 30 minutes at room temperature, then, the distance of the evaluation lines on the, specimen wasmeasured. The heat shrinkage percentage was calculated by the following formula.

Heat shrinkage percentage=100×((10−distance of evaluation lines(cm) after heating)/10)

The propylene-based polymers used in Examples and Comparative Examples were shown below.

A-1:

A propylene homopolymer resin, the trade name: Cosmoprene FS 3011P, manufactured by The Polyolefin Company (Singapore)Pte. Ltd., MFR=2.8 g/10 min., SR=1.31, Tm=159.2° C., the amount of 20° C. xylene-soluble portion(CXS)=2.5% by weight.

A-2:

A propylene homopolymer resin, the trade name: Sumitomo Noblen FS2016, manufactured by Sumitomo Chemical Co., Ltd., MFR=2.2 g/10 min., SR=1.28, Tm=161° C., the amount of 20° C.xylene-soluble portion(CXS)=2.8% by weight.

B-1:

A propylene homopolymer obtained in Reference Example described below.

### Reference Example 1

[1] Synthesis of Solid Catalyst Component

After the atmosphere of a 200 liter stainless steel reaction vessel with a stirrer was replaced with nitrogen, 80 liter of hexane, 6.55 mol of tetrabutoxytitanium, 2.8 mol of diisobutyl phthalate, and 98.9 mol of tetraethoxysilane were charged therein to obtain a homogeneous solution. Then, 51 liter of a diisobutyl ether solution of butylmagnesium chloride with a concentration of 2.1 mol/litter was gradually added dropwise over 5 hours while keeping the temperature inside of the reaction vessel at 5° C. After completion of dropwise addition, it was further stirred for 1 hour at room temperature, then solid-liquid separation was carried out at room temperature, and washing with 70 litter of toluene was repeated three times.

Then, after toluene was added so that the slurry concentration is 0.6 Kg/litter, a mixed solution of 8.9 mol of n-butyl ether and 274 mol of titanium tetrachloride was added, 20.8 mol of phthalic chloride was further added, and the mixture was stirred at 110° C. for 3 hours. Then, the solid-liquid separation was carried out, and the resulted solid was washed twice with 90 litter of toluene at 95° C.

After the slurry concentration was adjusted at 0.6 Kg/litter., 3.13 mol of diisobutyl phthalate, 8.9 mol of n-butyl ether and 137 mol of titanium tetrachloride were added, and the mixture was stirred at 105° C. for 1 hour. Then, after the solid-liquid separation was carried out at the same temperature, resulted solid was washed twice with 90 litter of toluene at 95° C.

Then, after the slurry concentration was adjusted at 0.6 Kg/litter, 8.9 mol of n-butyl ether and 137 mol of titanium tetrachloride were added, and the mixture was stirred at 95° C. for 1 hour. Then, after the solid-liquid separation was carried out at the same temperature, the resulted solid was washed three times with 90 litter of toluene at the same temperature.

Then, after the slurry concentration was adjusted at 0.6 Kg/litter, 8.9 mol of n-butyl ether and 137 mol of titanium tetrachloride were added, and the mixture was stirred at 95° C. for 1 hour. Then, after the solid-liquid separation was carried out at the same temperature and the resulted solid was washed three times with 90 litter of toluene at the same temperature, washed three times with 90 litter of hexane, and was dried under reduced pressure to obtain 11.0 Kg of a solid catalyst component.

The solid catalyst component contains 1.9% by weight of titanium atom, 20% by weight of magnesium atom, 8.6% by weight of a phthalic acid ester, 0.05% by weight of an ethoxy group, and 0.21% by weight of a butoxy group, and had a good particle property free from fine powder.

[2] Pre-Activation of Solid Catalyst Component

In an inner volume of 3 liter stainless steel autoclave with a stirrer, 1.5 liter of hexane which was sufficiently dehydrated and deaerated, 37.5 mmol of triethylaluminum, 3.75 mmol of t-butyl-n-propyldimethoxysilane and 15 g of the solid catalyst component obtained in the above-mentioned [1], were added, and 15 g of propylene was continuously fed over 30 minutes while keeping a temperature in the vessel at 5 to 15° C., to carry out a pre-activation.

[3] Production of Crystalline Propylene Polymer Portion (a)

In a polymerization vessel having an inner volume of 300 liter, made of SUS, while feeding liquid propylene at a rate of 57 kg/h so as to keep a polymerization temperature of 60° C. and a polymerization pressure of 27 kg/cm², 1.3 mmol/h of triethylaluminum, 0.13 mmol/h of t-butyl-n-propyldimethoxysilane and 0.51 g/h of the pre-activated solid catalyst component which was obtained in the above-mentioned [2], were continuously fed, and the polymerization of propylene was carried out in the substantial absence of hydrogen to obtain 2.0 kg/h of a polymer. The amount of the polymer obtained was 3920 g per 1 g of the solid catalyst component, a part of the polymers was sampled to be analyzed, and as a result, the intrinsic viscosity was 7.7 dl/g. The polymer powder containing the catalyst obtained was transferred to the second vessel as it was.

[4] Production of Crystalline Propylene Polymer Portion (b)

In a lm³ fluidized-bed polymerization vessel(the second vessel) having an inner volume of 1 m³, with a stirrer, while feeding propylene and hydrogen so as to keep a polymerization temperature of 80° C., a polymerization pressure of 18 kg/cm² and a hydrogen concentration of 8% volume at gas phase portion, 2.0 g/h of the polymer containing thecatalyst which was transferred from the first vessel, 60 mmol/h of triethylaluminum, and 6 mmol/h of t-butyl-n-propyldimethoxysilane, were continuously fed, and the polymerization of propylene was sequentially continued to obtain 18.2 kg/h of a polymer powder. The intrinsic viscosity was 1.9 dl/g.

From the result above, the preparation amount of the polymer at polymerization of the polymer portion (b) was 31760 g per 1 g of the solid catalyst component, the polymerization weight ratio of the first vessel to the second vessel was 11:89, and the intrinsic viscosity of the polymer portion (b) was determined as 1.2 dl/g.

[5] (Pelletization of Polymer)

0.1 part by weight of calcium stearate, 0.05 part by weight of IRGANOX 1010 (trade name, manufactured by Ciba Specialty Chemicals Ltd., and 0.2part by weight of SUMILIZER BHT (trade name, manufactured by Sumitomo Chemical Co., Ltd.) were added to 100 parts by weight of the polymer powder obtained in the above-mentioned [4] and the mixture was melt-kneaded at 230° C. obtain pellet of a propylene homopolymer having an intrinsic viscosity of 1.74 dl/g, weight average molecular weight (Mw) of 3.4×10⁵, molecular weight distribution (Mw/Mn) of 8.0, MFR of 12 g/19 min., die swelling ratio (SR) of 2.35, Tm of 165.2° C., and the amount of 20° C. xylene-soluble component (CXS) of 0.4% by weight.

### Example 1

After mixing 90 parts by weight of the propylene-based polymer A-1 and 10 parts by weight of the propylene-based polymer B-1 with a Henschel mixer, the mixture was granulated and pelletized at 220° C. using a 65 mm φ extruder. The MFR, Tm and CXS were measured according to the fore-mentioned methods. The results were shown in Table 1. The pellet obtained was subjected to Film forming (I) as described above, and the stretching processability was evaluated according to Evaluation of stretching processability (II) as described above. The results of film properties and the stretching processability were shown in Table 2.

### Comparative Example 1

The MFR, Tm and CXS of the propylene polymer A-1 were measured according to the fore-mentioned methods. The results were shown in Table 1. The propylene polymer A-1 was processed to make a film according to Film forming(I), and the stretching processability was evaluated according to Evaluation of stretching processability (II) as described above. The results of film properties and the stretching processability were shown in Table 2.

### Comparative Example 2

The MFR, Tm and CXS of the propylene polymer A-2 were measured according to the fore-mentioned methods. The results were shown in Table 1. The propylene polymer A-2 was processed to make a film according to Film forming(I), and the stretching processability was evaluated according to Evaluation of stretching processability (II) as described above. The results of film properties and the stretch processability were shown in Table 2.

TABLE 1

| | Adjustment of polypropylene | | | | | | |
|---|---|---|---|---|---|---|---|
| | resin composition | | | | | | |
| | | | Blend | | | | |
| | Propylene | Propylene | ratio | | | | |
| | -based | -based | A/B | | MFR | Tm | CXS |
| | polymer A | polymer B | (%) | SR | (g/10 min.) | (° C.) | (%) |
| Example 1 | A-1 | B-1 | 90/10 | 1.37 | 3.2 | 160.1 | 2.2 |
| Comparative | A-1 | — | 100/0 | 1.31 | 2.8 | 159.2 | 2.5 |
| Example 1 | | | | | | | |
| Comparative | A-2 | — | 100/0 | 1.34 | 2.2 | 161.6 | 2.8 |
| Example 2 | | | | | | | |

TABLE 2

| | | Anti- | Young's modulus | | Heat shrinkage | | |
|---|---|---|---|---|---|---|---|
| | | blocking | of elasticity | | percentage | | |
| | Haze | property | MD | TD | MD | TD | Stretch- |
| | (%) | (kg/cm²) | (kg/cm²) | (kg/cm²) | (%) | (%) | ability |
| Example 1 | 0.2 | 0.41 | 22500 | 45900 | 4.3 | 5.0 | Good |
| Comparative | 0.2 | 0.40 | 21600 | 44200 | 4.9 | 5.4 | Good |
| Example 1 | | | | | | | |
| Comparative | 0.2 | 0.34 | 22300 | 46600 | 4.8 | 6.3 | Bad |
| Example 2 | | | | | | | |

It can be found that Example 1 satisfying the requisite of the present invention is superior in haze (transparency), antiblocking property, Young's modulus (rigidity), heat shrinkage percentage and stretching processability.

To the contrary, it is found that Comparative Examples 1 and 2 not using the propylene-based polymer (B) which is essential in the present invention are insufficient in Young's modulus(rigidity) and heat shrinkage percentage, and insufficient in Young's modulus(rigidity) and heat shrinkage percentage and stretching processability, respectively.

As described in detail above, according to the present invention, a polypropylene-based resin composition for a stretched film having an excellent rigidity and stretch processability, and a small heat shrinkage percentage, a process for producing the resin composition, and a polypropylene-based stretched film obtained using the resin composition can be provided.

1. A polypropylene-based resin composition for a stretched film, comprising 20 to 99.99% by weight of a propylene-based polymer(A) having a die swelling ratio of less than 1.7, and 0.01 to 80% by weight of apropylene-based polymer(B) having a die swelling ratio of 1.8 or more.

2. The polypropylene-based resin composition according to claim 1, wherein the propylene-based polymer(B) is a propylene-based polymer(C) which is obtained by a polymerization process comprising a step of producing 0. 05 to 35% by weight of a crystalline propylene polymer portion(a) having an intrinsic viscosity of 5 dl/g or more and a step of producing 99.95 to 65% by weight of a crystalline propylene polymer portion(b) having an intrinsic viscosity of less than 3 dl/g, and has an intrinsic viscosity of less than 3 dl/g and a molecular weight distribution of less than 10.

3. A process for producing a polypropylene-based resin composition of claim 1 or 2, which comprises separately producing the propylene-based polymer(A) and the propylene-based polymer(B), respectively, and mixing the propylene-based polymer(A) and the propylene-based polymer(B) separately produced.

4. Aprocess for producing apolypropylene-based resin composition of claim 1 or 2, which comprises producing the propylene-based polymer(A) and the propylene-based polymer(B), respectively, at any step by a multi-step polymerization process.

5. A polypropylene-based resin stretched film which is obtained by stretching the polypropylene-based resin composition of claim 1 or 2 to uniaxial or biaxial directions.
